(19) United States
(12) Patent Application Publication
(10) Pub. No.: US 2026/0008579 A1
(43) Pub. Date: Jan. 8, 2026

(54) LABELING MACHINE FOR LABELING CONTAINERS

(71) Applicant: Krones AG, Neutraubling (DE)

(72) Inventors: Thomas EGGL, Obertraubling (DE); Jörg TRIEBEL, Alteglofsheim (DE)

(21) Appl. No.: 19/260,004

(22) Filed: Jul. 3, 2025

(30) Foreign Application Priority Data
Jul. 4, 2024 (DE) 10 2024 119 045.0

(51) Int. Cl. B65C 9/04

(52) U.S. Cl. CPC B65C 9/04

(57) ABSTRACT

A labeling machine for labeling containers includes a container receptacle for rotatably receiving a container and for transporting the container along a transport direction, a functional component for carrying out a function associated with labeling the container at a position of the container along the transport direction, and a control unit. The control unit is configured to determine a necessary rotation of the container on the basis of a manually defined rotational position of the container in the receptacle at the position and to control the rotation of the container.

### CROSS-REFERENCE TO RELATED APPLICATIONS

This application claims priority to German Patent Application No. 102024119045.0, filed Jul. 4, 2024, the contents of which are incorporated by reference herein in their entirety.

### TECHNICAL FIELD

The present invention relates to a labeling machine for labeling containers and to a method for labeling containers by means of a labeling machine.

### BACKGROUND ART

Labeling machines for labeling containers are well-known in the prior art. These can, for example, apply one or more labels to the containers by using rotary machines with a large number of container receptacles and labeling units arranged stationary along the periphery of the rotary machine.

For reasons of the quality of the labeling result and also requirements regarding the positions of the labels on the bottle, it may be necessary to rotate the containers during the labeling process. The necessary rotational positions or rotational settings of the container are usually specified by an operator in complex procedures, wherein the respective rotational position of the container at a certain position along the transport direction is input by the operator and, on the basis of the large number of positions input, the necessary rotation curve is then determined and this is subsequently used to control the rotation of the containers during transport in the labeling machine.

However, the known methods are complex and require a great deal of experience on the part of an operator, so they also have a certain susceptibility to errors.

### BRIEF SUMMARY

Aspects of the invention relate to a labeling machine for labeling containers as well as a method for labeling containers with a labeling machine. In these methods, the determination of the necessary rotation curves for controlling the rotation of containers is reliable and easier for an operator. Advantageous developments of the invention are disclosed in the dependent claims.

A labeling machine for labeling containers according an embodiment of the invention comprises a container receptacle for rotatably receiving a container and for transporting the container along a transport direction, a functional component for carrying out a function associated with labeling the container at a position of the container along the transport direction, and a control unit, wherein the control unit is configured to determine a necessary rotation of the container on the basis of a manually defined rotational position of the container in the receptacle at the position and to control the rotation of the container.

For the purposes of the invention, the manually defined rotational position of a container is to be understood as the manual action on a container positioned in the container receptacle so that the container is brought into a desired position by manual rotation, which then defines the defined rotational position. The desired rotational position can, for example, be specified depending on a desired rotational position for applying a label, for example relative to a seam of the container.

The position is to be understood as the position in which the functional component performs its function on the container. The position can, for example, be the position at which a label is transferred to a container and, for example, a certain angular position of a carousel that transports the container receptacles along its direction of rotation. This position is accompanied by a desired rotational position of the container, so that by bringing the container into the position and then adjusting the rotational position, an exact assignment of the position and the specified rotational position of the container is predetermined, which can then be used advantageously to determine the necessary rotation.

A functional component is any component of the labeling machine that performs an action on the container that is related to the labeling of the container. This includes, for example but is not limited to, transferring one or more labels to a container, brushing-on the label onto the container, inspecting the label and the like.

The necessary rotation of the container can be determined as a differential rotation, for example, taking into account a starting position of the container when it is transferred to the labeling machine or can be the rotational position of the container after passing a previous functional component, and can be determined, for example, as a degree indication or as a function which, depending on the path traveled by the container along the transport direction or the transport time traveled along the transport direction, determines the change in the rotation of the container from a starting position to the specified rotational position when the position has been reached.

According to embodiments of the invention, the fact that the rotation of the container is controlled is to be understood in such a way that, during operation of the labeling machine, containers to be labeled are rotated using the specific necessary rotation in the container receptacle, so that when the position is reached, the necessary rotation is or has been carried out and the specified rotational position is assumed by the container, so that the functional component can correctly perform the function at the position of the container.

With the apparatus according to an embodiment of the invention, the operator can easily set the different rotational positions in the positions associated with the functional components and the execution of the relevant functions by rotating a container in the container receptacle in the respective position and thereby reliably determine the necessary rotation automatically, so that the subsequent control of the labeling machine in normal operation is reliably possible. The effort required for an operator as well as the requirements for the operator's technical know-how are thus reduced.

It can be provided that the functional component comprises at least one of a labeling unit, a brushing-on unit, an inspection device. These functional components are usually present as part of the labeling machine and the advantages of the invention can be applied thereto.

In one embodiment, the position is at least one of a label transfer position, a brushing-on position, or an inspection position. These positions are well-defined along the transport direction of a container in the labeling machine and can therefore easily be assigned a fixed rotational position of the container.

It can be provided that the labeling machine comprises a second functional component downstream of the functional component for carrying out a second function associated with labeling the container at a second position downstream of the position along the transport direction, and wherein the control unit is configured to determine a necessary second rotation from the rotational position to the second rotational position on the basis of a manually defined second rotational position of the container in the receptacle at the second position and to control the rotation of the container from the rotational position to the second rotational position.

With this embodiment, it is possible to take into account functional components arranged one after the other along the transport direction and to determine the rotational positions required in each case. For example, a change in the rotational position of the container from a first labeling unit to a subsequent first brushing-on unit or between a first labeling unit and a second labeling unit can be easily defined and the necessary rotation of the container can be determined based on this. Even with complex labeling processes, such as applying a label to the front and a label to the back, an operator can easily determine the necessary rotations.

It can be provided that the labeling machine comprises a plurality of container receptacles, and wherein the control unit is configured to determine the necessary rotation of containers for all container receptacles on the basis of a manually defined rotational position of the container and to control the rotation of containers in all container receptacles. This embodiment reduces the number of necessary determinations of container rotational positions, which further simplifies the interaction of an operator with the labeling machine.

The control unit can be configured to determine the necessary rotation of containers for all container receptacles on the basis of exactly one manually defined rotational position of the container and to control the rotation of containers in all container receptacles. This embodiment advantageously allows all necessary rotations and rotational positions of a container to be defined for all container receptacles merely by positioning a single container and defining the respective rotational positions, which further reduces the effort for an operator.

The control unit may be configured to compare the determined rotation with a limit value and to output information to an operator based on a result of the comparison.

The fact that information is issued to an operator based on the result of a comparison can in particular include that if the limit value is exceeded or if the limit value is undershot, depending on what is indicative of a malfunction or an impossibility of rotation of the container, for example, the operator will be informed of this technical condition of the labeling machine and, for example, an alternative rotational position can be specified. This improves the reliability of labeling a container.

It can be provided that the labeling machine comprises a display device, and wherein the control unit is configured to display on the display device the manually defined rotational position and/or the position and/or the necessary rotation.

The additional technical information derived from the manually defined rotational position as well as the defined rotational position itself are thus made easily accessible to the operator, which further simplifies the operation of the labeling machine.

According to an embodiment of the invention, a method for labeling a container with a labeling machine is further provided, the labeling machine comprising a container receptacle for rotatably receiving a container and for transporting the container along a transport direction, a functional component for carrying out a function associated with labeling the container at a position of the container along the transport direction, and a control unit. The method may comprise determining, using the control unit, a necessary rotation of the container on the basis of a manually defined rotational position of the container in the receptacle at the position, and controlling the rotation of the container. This procedure makes possible a simplified adjustment of the necessary rotations of the container.

In one embodiment, it is provided that the functional component comprises at least one of a labeling unit, a brushing-on unit, an inspection device; and/or

wherein the position is at least one of a label transfer position, a brushing-on position, an inspection position.

These positions and functional components are commonly used in labeling machines and are associated with well-defined positions, so that the invention can be particularly advantageously applied to these embodiments.

It can be provided that the labeling machine comprises a second functional component downstream of the functional component for carrying out a second function associated with labeling the container at a second position downstream of the position along the transport direction. In that case, the method may further comprise determining, using the control unit, a necessary second rotation from the rotational position to the second rotational position on the basis of a manually defined second rotational position of the container in the receptacle at the second position, and controlling the rotation of the container from the rotational position to the second rotational position.

This also allows successive rotations along the transport of the container from one functional component to another functional component to be determined and taken into account in the control.

The labeling machine may comprise a plurality of container receptacles and the control unit may determine the necessary rotation of containers for all container receptacles on the basis of a manually defined rotational position of the container and control the rotation of containers in all container receptacles. This embodiment reduces the effort required to determine the rotations even when the labeling machine has a large number of container receptacles.

In particular, it can be provided that the control unit determines the necessary rotation of containers for all container receptacles on the basis of exactly one manually defined rotational position of the container and controls the rotation of containers in all container receptacles.

This means that it is sufficient to set a defined rotational position for a single container in order to automatically determine the necessary rotations for any number of container receptacles, which further improves the usability of the labeling machine.

It can be provided that the control unit compares the determined rotation with a limit value and outputs information to an operator based on a result of the comparison. Incorrect rotational positions specified by the operator can be detected and corrected by the operator.

The labeling machine may comprise a display device and the control unit may display the manually defined rotational position and/or the position and/or the determined rotation on the display device. The fact that the control unit displays the relevant information on the display device is to be understood here as meaning that the control unit controls the display device in such a way (for example by issuing corresponding control commands to the control unit) that the display device (such as an LCD display or monitor or similar) displays the information. This allows the operator to be informed about relevant technical information for the operation of the labeling machine.

### BRIEF DESCRIPTION OF THE DRAWING FIGURES

FIG. 1 shows a schematic view of a labeling machine according to an embodiment; and

FIG. 2 shows a flowchart of a method for labeling a container according to an embodiment.

### DETAILED DESCRIPTION

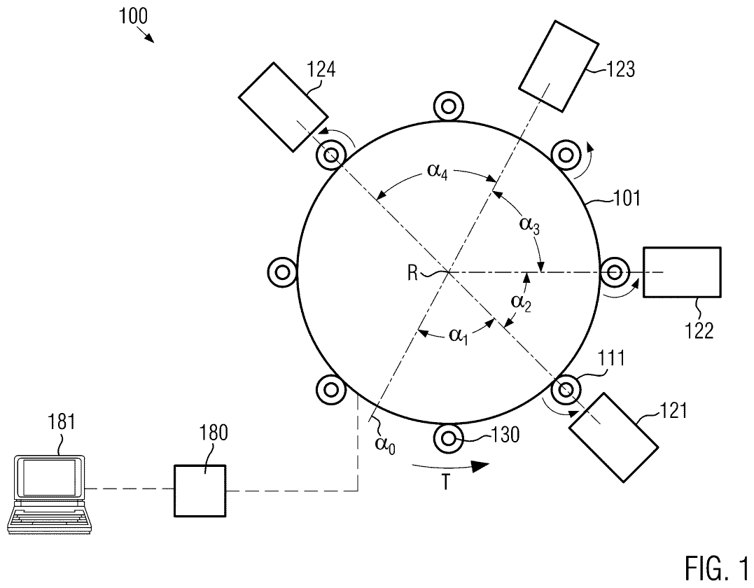

FIG. 1 shows a labeling machine according to an embodiment of the invention. The labeling machine is configured for labeling containers 130 such as bottles, cans or the like.

In the embodiment shown here, the labeling machine 100 comprises a carousel 101 which is mounted rotatably about a rotation axis R and which comprises on its circumference a plurality of container receptacles 111 for rotatably receiving a container 130. The container receptacles are not limited in terms of their embodiment, but can, for example, comprise a turntable and a corresponding centering bell in order to clamp a container between the turntable and the centering bell in a manner known in principle. By rotating the turntable, the container can then be rotated about its longitudinal axis in the container receptacle, for example.

The containers are transported in the container receptacles 111 along the direction of rotation T or the transport direction T of the carousel when the carousel rotates about its axis of rotation R. In the embodiment shown here, the labeling machine 100 comprises, one after the other in the direction of rotation, a plurality of functional components 121 to 124 which are generally configured to carry out at least one function associated with the labeling of a container on the container. The functions associated with labeling can basically include all process steps related to labeling the container. This includes in particular the application or transfer of a label to the surface of the container. This can be done, for example, by a known labeling unit such as the labeling unit 121. The function can also or alternatively comprise, for example, brushing-on the label by a brush 122 or a subsequent inspection, for example with the functional component 124 in the form of an inspection device such as a camera. The functional component 123 can, for example, be another labeling unit with or without downstream brushing-on.

However, the invention is not limited with regard to the number and arrangement as well as type of functional components. Even just one or more than the 4 shown or only 2 or 3 functional components can thus be provided.

In particular, in embodiments of the labeling machine 100 with a plurality of different functional components, it may be necessary for the container to be rotated in the container receptacle during transport from the first functional component to the second functional component, so that the container assumes a specific rotational position. However, this does not only apply to a large number of functional components but may also be necessary for a single functional component which, for example, is intended to apply a label to the container, if, for example, the label is to be attached in a certain relative orientation to a seam of the container or to another feature of the container.

Each functional component is associated with a specific predefined position of the container receptacle, which the container receptacle assumes here, for example, along the circumferential direction of the carousel when the functional component performs the respective function. The position can, for example, be a predetermined angular position of the container receptacle starting from an arbitrarily selected but fixed starting position α₀. This represents an angle of rotation by which the carousel is rotated starting from position α₀ until the container receptacle assumes the respective position associated with the functional component.

In the embodiment shown here, a plurality of positions are provided, each associated with a functional component. However, the invention is not limited with regard to the number of positions or their exact location.

By way of example, FIG. 1 shows that the position α₁ corresponding to an angle of rotation, seen from the initial angle of rotation α₀ (which can be arbitrarily set equal to 0) is associated with the first functional component 121. A rotational position α₂ offset relative to the position α₁ is associated with the second functional component 122, so that compared to the starting position a position α₁+α₂ is associated. Accordingly, a rotational position as with respect to the second position and α₁+α₂ as with respect to the starting position α₀ is associated with the third functional component and a position α₄ with respect to the third functional component or its position or α₁+α₂+α₃+α₄ with respect to the starting position α₀ is associated with the fourth functional component 124.

According to the invention, it is provided that the labeling machine 100 can transfer a container receptacle 111 with a container positioned therein into the positions assigned to the functional components. For this purpose, for example, the carousel can be rotated so that the container receptacle and/or the container arranged therein is arranged in the position, for example in the position α₁. The carousel can then be locked in this position, for example by stopping one of the carousel's drives.

In the respective positions, an operator can then manually set a defined rotational position of the container, for example by rotating the container together with the container receptacle by hand. For example, a particular rotational position of the container may be required for the application of the label so that the label covers a container seam or other feature of the container or is arranged in a certain way relative to it. In the case of several functional components and in particular several labeling units, it can be provided that, for example, a first label is applied to a front side and a second label is applied to the back of the container, so that the rotational positions to be defined of the container or of the container receptacle with the container arranged therein are substantially opposite or the container has to be rotated by 180°. Again, relative to an arbitrary starting position of the turntable in relation to the starting position assigned to the respective turntable or container receptacle, this corresponds to a specific angle of rotation which is set by the operator as a defined angle of rotation by manual operation.

The manually defined rotational position of the container or the container receptacle and, if applicable, the respective position associated with the functional component can be transmitted according to the invention to a control unit 180, such as a computer with a processor and associated memory. The control unit 180 can determine a necessary rotation of the container or the container receptacle from the respective fixed rotational position in the receptacle at the respective position.

This includes, for example, that, starting from a starting position of the container receptacle or the container in position α₀, a rotation of the container and the container receptacle until the position α₁ is reached is carried out in such a way that the container is rotated exactly enough to reach the defined rotational position associated with the position α₁. The necessary rotation can be determined, for example, as a function f(α), i.e. a function depending on the position of the container receptacle along the periphery of the carousel, wherein f(α₁) then corresponds to the defined rotational position. When the carousel rotates, the container receptacle and the container arranged therein are rotated depending on the respective position of the container receptacle (the associated angle of rotation α of the carousel) so that when the position α₁ is reached the container will have reached the defined rotational position.

This may also require the successive setting of a large number of necessary rotations between the different positions assigned to the functional components, in particular in the case of the presence of a large number of functional components, as shown by way of example in FIG. 1, in which the container(s) in the respective container receptacles are rotated along a predetermined direction of rotation or also in the opposite direction.

If the necessary rotations have been specified by the control unit (for example as functions f as described above), the control unit can then control the rotation of the containers in the respective container receptacles during operation of the labeling machine 100.

It is preferred if the control unit is further configured so that, even in the case of a large number of container receptacles, only a small number of defined rotational positions are required in order to determine the necessary rotations for all container receptacles. In this case, it can be provided that the control unit has, for example, suitable information about the respective container receptacles, for example stored in the memory of the control unit, on the basis of which, with an indication of a defined rotational position of a container for just one container receptacle 111, not only the necessary rotations of a container in this container receptacle 111 can be determined, but also the necessary rotations of containers in all container receptacles of the labeling machine 100 can be determined. Since the container receptacles can basically all be configured identically and the necessary rotations only have to be carried out from the respective positions starting from a defined starting position α₀, this may include, for example, copying the determined rotations required for one container receptacle into data associated with the other container receptacles. If the positions of other container receptacles differ from the starting position α₁ of the container receptacle, for example, by integer multiples of a difference angle Δα (wherein Δα is the angle difference of the starting position α₁ of the container receptacle 111 and an immediately, i.e., directly adjacent other container receptacle), for a container receptacle n (which is the nth nearest neighbor of the container receptacle 111 contrary to the direction of rotation of the carousel), the function f can be determined, for example, as f=f(α−nΔα), so that if this container receptacle has the position α₁ starting from its respective starting position relative to the container receptacle 111 and assuming α₀=0, the rotation of the container will be such that it corresponds to the defined rotational position.

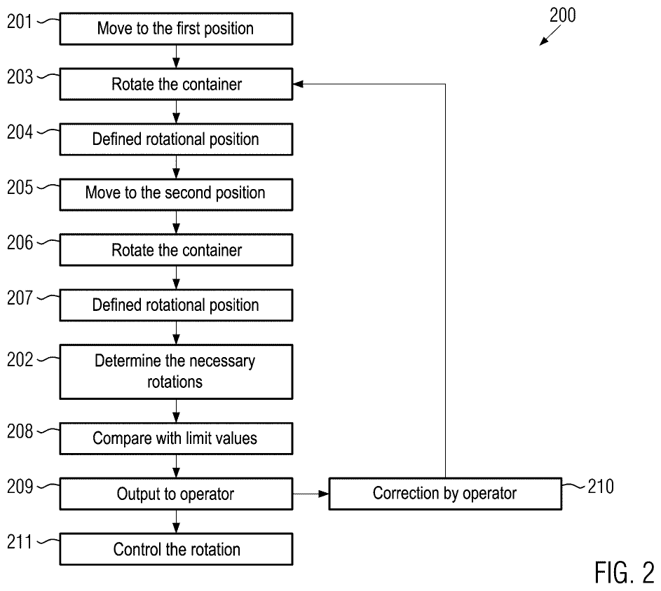

The labeling machine 100 may further comprise a display device 181, for example in the form of a display with an optionally associated keyboard. It can be provided that the control unit is configured to display on the display device 181 information regarding the operation of the labeling machine and in particular the manually defined rotational position in the respective position and/or the respective position and/or the necessary rotation determined by the control unit and/or further information, as explained in conjunction with FIG. 2. This can make it easier for the operator to check the specific necessary rotations for plausibility, for example, or to check the technical data relevant to the operation of the labeling machine.

FIG. 2 shows a flowchart of a method 200 for labeling a container according to one embodiment. All embodiments described in conjunction with FIG. 2 can be realized with the labeling machine according to the embodiments of FIG. 1 and are thus provided in direct combination with each of the described embodiments.

The method 200 may include one or more preceding steps that are not shown here. For example, an operator can load a container into a specific container receptacle and leave this container receptacle in the starting position do described in conjunction with FIG. 1. It may also be provided that the container receptacle or the container therein is positioned in a specific initial rotational position, which corresponds, for example, to the rotational position of the container in which it is transferred to the labeling machine.

Next, in step 201, the position associated with the functional component is first approached. This can be done either by manually rotating the carousel or moving the transport device further or, for example, by actuating a corresponding input apparatus by the control unit, by actuating a drive of the labeling machine, such as in particular the rotary drive of the carousel or a drive of a transport device, in order to move the container receptacle from the starting position to the first position, such as the position marked by the angle α₁ in FIG. 1. Here, the position of the carousel can optionally be fixed so that it cannot be moved relative to the respective functional component, which could otherwise lead to inaccuracies when setting the specified rotational position.

In the next step 202, an operator manually rotates the container in the container receptacle and thus also rotates, for example, the container receptacle or a component of the container receptacle, such as the turntable, from an initial rotational position to the rotational position defined by the operator, such as a rotation of 45° or similar.

A fixed rotational position 203 is thus achieved, which can be detected by the control unit and, for example, stored in a memory. The specified rotational position can be determined by the control unit 180, for example, by visual or electronic detection, such as reading a position marking or the position of a pinion, so that the operator only has to manually specify the desired rotational position of the container and the relevant information is automatically determined by the control unit.

In the optionally marked steps 204 to 206, the method is then repeated if several functional components are present, so that, for example, the container receptacle is moved from the first functional component 121 of FIG. 1 to the second functional component 122 or into the position associated therewith. The operator then determines the specified rotational position again by manually rotating the container, which can then be detected and stored by the control unit in step 206, for example.

On the basis of the defined rotational position(s), the control unit then determines the necessary rotations of the respective container receptacles in step 207 and can, for example, also determine the necessary drive commands for driving the container receptacle, for example an associated servo drive.

Since the transport of the container receptacles or the containers along the transport direction to the respective functional components only provides a limited time window for effecting the rotation, each rotation to be defined by the control unit in order to reach the respectively specified rotational position must take place within the available time window. This may mean that an acceleration of the container receptacle or of the container or a rotation speed of the container is necessary in order to reach the respective specified rotational position, which are outside a permissible range. The same applies to all operating parameters or physical parameters associated with the rotation of a container. These may normally only occur within certain limits when operating a labeling machine and may not exceed or fall below the limit values associated with these limits.

It can be therefore provided that in step 208 the control unit compares the determined necessary rotations or associated operating parameters or physical parameters with predetermined limit values in order to determine whether the rotations necessary to reach the respectively defined rotational position are within the scope of the permissible operation of the labeling machine. For example, the control unit can check whether an acceleration of a container exceeds a limit when in application of the determined necessary rotation.

Next, an output to an operator can optionally be made in step 209, wherein the output contains, for example, the specified rotational position and/or the necessary rotation or other information. In particular, the output may include displaying the operating parameters or physical parameters associated with the rotation and/or displaying whether and to what extent predetermined limit values are exceeded or undershot. Information can also be provided that the specified rotational position cannot be reached due to limit values being exceeded or not met.

If this is the case, a request can be output to the operator in step 210 to correct the specified rotational position. For example, the operator can also be given a possible solution suggestion. If, for example, the required rotation of the container from a first rotational position to a second rotational position due to the direction of rotation specified by the operator is greater than 180°, the alternative can be that the container is rotated in the opposite direction, since then a shorter angular distance has to be covered, which, for example, reduces the acceleration or the required rotational speed.

Optionally, if a correction of the defined rotational position is necessary in step 210, the process can be repeated with step 201 or 202 if the container receptacle is already positioned in the respective position.

If the necessary rotations meet the specified limit values either after correction or already during the first input, the operation of the labeling machine can then be started in step 211 and the rotation of the containers in the container receptacles can be controlled according to the specified rotational positions and the necessary rotations determined therefrom. Furthermore, the functions of the functional components can be controlled so that the labeling of the container is carried out with all necessary process steps.

What is claimed is:

1. A labeling machine for labeling containers, the labeling machine comprising:
a container receptacle for rotatably receiving a container and for transporting the container along a transport direction,
a functional component for carrying out a function associated with labeling the container at a position of the container along the transport direction, and
a control unit,
wherein the control unit is configured to determine a necessary rotation of the container based on a manually defined rotational position of the container in the receptacle at the position and to control the rotation of the container.

2. The labeling machine according to claim 1, wherein the functional component comprises at least one of a labeling unit, a brushing-on unit, or an inspection device.

3. The labeling machine according to claim 1, wherein the position is at least one of a label transfer position, a brushing-on position, or an inspection position.

4. The labeling machine according to claim 1, wherein the labeling machine comprises a second functional component downstream of the functional component for carrying out a second function associated with labeling the container at a second position downstream of the position along the transport direction, and wherein the control unit is configured to determine a necessary second rotation from the rotational position to the second rotational position on the basis of a manually defined second rotational position of the container in the receptacle at the second position and to control the rotation of the container from the rotational position to the second rotational position.

5. The labeling machine according to claim 1, wherein the labeling machine comprises a plurality of container receptacles, and wherein the control unit is configured to determine the necessary rotation of containers for all container receptacles on the basis of a manually defined rotational position of the container and to control the rotation of containers in all container receptacles.

6. The labeling machine according to claim 5, wherein the control unit is configured to determine the necessary rotation of containers for all container receptacles on the basis of exactly one manually defined rotational position of the container and to control the rotation of containers in all container receptacles.

7. The labeling machine according to claim 1, wherein the control unit is configured to compare the determined rotation with a limit value and to output information to an operator on the basis of a result of the comparison.

8. The labeling machine according to claim 1, wherein the labeling machine comprises a display device, and wherein the control unit is configured to display the manually defined rotational position and/or the position and/or the necessary rotation on the display device.

9. A method for labeling a container with a labeling machine, the labeling machine including a container receptacle for rotatably receiving a container and for transporting the container along a transport direction, a functional component for carrying out a function associated with labeling the container at a position of the container along the transport direction, and a control unit, the method comprising:
determining, using the control unit, a necessary rotation of the container on the basis of a manually defined rotational position of the container in the receptacle at the position; and
controlling the rotation of the container in accordance with the determining.

10. The method according to claim 9, wherein the functional component comprises at least one of a labeling unit, a brushing-on unit, an inspection device; and/or
wherein the position is at least one of a label transfer position, a brushing-on position, an inspection position.

11. The method according to claim 9, wherein the labeling machine includes a second functional component downstream of the functional component for carrying out a second function associated with labeling the container at a second position downstream of the position along the transport direction, and
wherein the method further comprises determining, using the control unit, a necessary second rotation from the rotational position to the second rotational position based on a manually defined second rotational position of the container in the receptacle at the second position, and
controlling the rotation of the container from the rotational position to the second rotational position.

12. The labeling machine according to claim 9, wherein the labeling machine includes a plurality of container receptacles, and
wherein
the determining further comprises determining, using the control unit, the necessary rotation of containers for all container receptacles on the basis of a manually defined rotational position of the container, and
the controlling further comprises controlling the rotation of containers in all container receptacles.

13. The method according to claim 12, wherein the control unit determines the necessary rotation of containers for all container receptacles on the basis of exactly one manually defined rotational position of the container and controls the rotation of containers in all container receptacles.

14. The method according to claim 9, wherein the control unit compares the determined rotation with a limit value and outputs information to an operator based on a result of the comparison.

15. The method according to claim 9, wherein the labeling machine comprises a display device, and wherein the control unit displays the manually defined rotational position and/or the position and/or the determined rotation on the display device.
